(19) United States
(12) Patent Application Publication
(10) Pub. No.: US 2023/0054856 A1
(43) Pub. Date: Feb. 23, 2023

(54) OPERATION-CONTROL DEVICE FOR OPERATION AND METHOD FOR CONTROLLING OPERATION OF A DISPERSER AND DISPERSER SYSTEM COMPRISING A DISPERSER AND A COMPUTER PROGRAM PRODUCT

(71) Applicant: BASF Coatings GmbH, Münster (DE)

(72) Inventors: Jan Berg, Münster (DE); Thomas Kondring, Münster (DE); Stefan Kiffer, Münster (DE); Sergej Gertje, Ludwigshafen (DE)

(21) Appl. No.: 17/785,753

(22) PCT Filed: Nov. 30, 2020
(86) PCT No.: PCT/EP2020/083950

§ 371 Date: Jun. 15, 2022

(30) Foreign Application Priority Data
Dec. 18, 2019 (EP) 19217533.9

(51) Int. Cl. G05B 19/042

(52) U.S. Cl. CPC G05B 19/0425; G05B 2219/14087; G05B 2219/14043

(57) ABSTRACT

Described herein is an operation-control device adapted for controlling operation of a disperser and including an input unit for receiving, from sensing devices, state-values (V₁, V₂, V₃) of at least two different physical entities and/or operational states of the disperser, such as temperature, pressure, etc. A functional-correlation storage unit is configured to store a functional correlation model including correlations of state-values of subsets of physical entities and/or operational states of the mill and indicative of a predetermined plausibility condition associated to a respective correlation. A plausibility-checking unit is configured to determine a flag to the plausibility condition and to provide a corresponding status signal.

The present invention is directed to an operation-control device for controlling operation of a disperser and further directed to a disperser system and to a method for controlling operation of a disperser and further directed to a computer program for said operation-control device for controlling operation of a disperser.

It is generally known in the prior art related to handling of liquids to control a technical apparatus wherein signalising means is used to produce control signals. An example is an apparatus like fillers in containers and handling thereof wherein signalising means is used to produce control signals, such as echo signals in the case of WO 2018/202387 A1. Advantageously therein the control signals are checked and/or evaluated via a plausibility check.

In particular WO 2018/202387A1 describes a method for monitoring the fill level of a filler in a container in a process apparatus with a fill level measurement device operating according to the time-of-flight principle, which emits transmission signals into the container in the direction of the filler and establishes an echo curve on the basis of signal components reflected back in the container during measurement operation. During the evaluation of the echo curve, a used echo signal of the echo curve is identified. During the determination and/or the monitoring of the fill level, the filler is subjected to at least one current process wherein information about the at least one current process is stored in the superordinate control unit. Therein on the basis of the information about the currently present process, the plausibility of the used echo signal is checked and the evaluation, in particular the identification of the used echo signal, is dynamically adapted to the currently present process in each case.

EP 3 428 756 A1 describes a method for ensuring the integrity of industrial automation systems by comparing status data pertaining to the operation status of the industrial automation system with sensor data which describes an effect of the environment of the automation system. This is referred to as checking consistency or plausibility and the method is performed for recognizing unauthorized external access to the automation system.

WO 2015/051884 A1 discloses a method for treating a mixture in a kneader-mixer and a kneader-mixer that includes a monitoring device. The monitoring device comprises a pressure sensor and a flow sensor that are connected to a central control unit. Flow is monitored at a constant pressure and an alarm is triggered when e.g. the flow rate suddenly or strongly increases.

Further, technically more complicated systems for handling liquid materials of chemical and/or technical relevance are systems of dispersers, having a rotating unit for rotating, working or dispersing a material in the liquid, also referred to as a rotor; in particular, such systems may have a rotor and a stator unit, the latter also referred to as stator. Such kind of more complicated systems for handling liquid materials in general and in particular liquid materials of chemical and/or technical relevance, however, have specific demands to be considered for control thereof.

In particular dispersers for handling liquid materials of chemical and/or technical relevance are considered to be constituted by any mixing device or milling device adapted for use to dissolve or disperse pigments and other solids into a liquid. Specifically, in the case of milling devices this is meant to further disperse particles in a solution. In the case of high-speed dispersers these are also referred to as dissolvers.

In this application, primarily, in a first variant disperser shall be understood to specifically include mills, in particular agitator or stirrer or ball or pebble mills, further mixers and kneaders suitable for dispersing or dissolving pigments and other solids into a liquid. Nevertheless, disperses in a second variant shall also include dissolvers, also referred to as highs-peed dispersers; such high-speed dispersers in particular comprise a stirring tank with a powerful high-speed stirrer. Still also, a disperser may be constituted as an in-line disperser with a rotor and possibly a stator in a pipe or the like line for liquid flow.

Such dispersing systems, in particular steering and milling system for production of materials of dispersed, i.e. dissolved pigments and other solids in a liquid, are generally known in the art; in particular, adapted for use to produce a paint or a lacquer. This is dispersers are considered to be constituted as a specific kind of fluid energy machines adapted to bring in energy into the pigments and other solids for dissolving the same into the liquid; in particular, to produce a paint or a lacquer.

In a usual process as follow up of a weigh-in step, a dispersion step follows, which is possibly constituted by one or more pre-dispersion and main-dispersion steps; the process is finalized in a complementing step; basics thereof are described in https://de.wikipedia.org/wiki/Dispergierung (Lack).

The operation of a disperser having a rotating unit for rotating in a liquid; in particular, a disperser may, or have a rotor and a stator unit or, in particular a mill or a dissolver or a disperser machine of the kind mentioned above. Such disperser can be monitored with various measuring instruments or sensing devices for sensing state-values of physical entities and/or operational states, such as, but not limited to material flowrate, pressure, viscosity, rotation speed, electrical power, density and temperature. This serves to ensure plant safety and to check the current operating condition. In contrast to particularly safety-critical plants, e.g. in refineries, measuring instruments in the case of mills are not redundant, and the reliability of the measuring signals is therefore lower.

The measured state-values of a given physical entity can be evaluated in an electronic control unit (e.g. DCS) and used to change the set values of that or other related physical entity. For instance, as an example, when a temperature threshold is reached, a cooling medium valve is opened further, thus increasing a flowrate of the cooling medium.

Dispersers as mentioned above, in particular such as mills or high-speed dispersers as the most prominent examples, are preferably used in batch operation—often in the so-called circular mode, in which the product properties are changed by the milling continuously. Changes in the state-value of a first physical entity such as, disperser speed, product throughput, cooling medium flowrate, etc., are directly related to changes in the state value of another physical entity such as temperature, viscosity, energy absorption or pressure occur. The readjustment of the operating parameters to optimize the performance is directly dependent on the quality of the measurement signals.

Thus, the problem arises that data evaluation of data provided by a sensing devices or other signal-generating devices which on its own lacks the necessary significance is usually not reliable and the use thereof, in particular the automatic use thereof in control strategies or control circuits is limited. It should be noted that this object is not merely solved in that to provide the control signals redundantly, as a measure which is an alternative method of improving quality, like as implemented in WO 2018/202387 A1.

It is therefore an object of the present invention to provide a device for improving the reliability of the control signals.

A solution to this problem in provided by an operation-control device of claim 1 in accordance with a first aspect of the present invention, by a disperser system of claim 10 in accordance with a second aspect of the invention, by a method of claim 12 in accordance with a third aspect of the invention and by a computer program of claim 15 in accordance with a fourth aspect of the present invention.

The invention has specific relevance to dispersers for liquid materials of chemical and/or technical relevance. Therein more specifically in a particular preferred development a disperser is to be understood as a mixing device used to disperse or dissolve pigments and other solids into a liquid. A disperser thus is configured to transport one phase or ingredient, in liquid, solid, gaseous state, into a main continuous phase, typically a liquid, with which it would normally be immiscible.

A rotor or impeller, in some developments together with a stationary component known as a stator, or an array of rotors or an array of rotors and stators, is used either in a tank containing the solution to be mixed, or in a pipe through which the solution passes, to create shear. A disperser is advantageously configured to create emulsions, suspensions, lyosols i.e., gas dispersed in liquid, and granular products. It is used in several technical fields including adhesives, chemical, cosmetic, food, pharmaceutical, and plastics industries, for emulsification, homogenization, particle size reduction, and dispersion. Dispersers, which are also referred to as dispersing units or dispersing machines are therefore devices that are advantageously used for dispersing solid components such as pigments or fillers, in the liquid phase of coatings and printing inks, in particular to produce a paint or a lacquer. Dispersing units introduce energy into the material to be ground either by rubbing said material two surfaces or by exerting impact and shear forces by rapidly rotating discs or pins. Depending on the viscosity of the ground material, dispensability of the pigments and fillers and the required quality of the coating material, different dispersers units are used.

A dispersing process in a particular preferred development is to be understood as a process step in the production of formulations such as coatings, printing inks, plastic or pigment preparations. The term is typically used to describe the incorporation of pigments or fillers into a carrier material. Dispersing is used, for example, to produce suspensions, i.e., a solid phase distributed in a liquid phase. In addition to uniform distribution in the carrier material, dispersion also describes the wetting of the substance to be dispersed with the carrier material, the comminution of the substance to be dispersed and the subsequent stabilization.

The operation-control device of the first aspect is suitably adapted for controlling operation of disperser and/or a system comprising a disperser, which have a rotating unit, or rotor for rotating or working or dispersing a material in a liquid. Particularly the disperser or the system comprising a disperser includes a mill, in particular a bead mill. Alternatively, or additionally the disperser and/or the system comprises a dissolver, also referred to as high-speed dispersers. The operation-control device is also suitable for systems comprising a mill or a dissolver.

More specifically according to the invention, the object of the invention is solved by an operation-control device comprising an input unit for receiving, from external associated sensing devices, state-values of at least two different physical entities and/or operational states of the disperser associated to a dispersing process of the disperser.

In particular, the physical entities and/or operational states of the disperser include, but are not limited to, material flowrate, pressure, viscosity, colour, rotation speed, electrical power, density and temperature at one or more locations within the disperser or its surroundings, such as, for example, the room-temperature value of a room in which the disperser is located.

The operation-control device also comprises a functional-correlation storage unit configured to store at least one functional correlation model comprising one or more correlations of state-values of a number of subsets of the different physical entities and/or the operational states of the disperser.

A state-value is defined as being indicative of a respective different state parameter of the dispersing process arising from a respective physical entity and/or the operational states of the disperser.

In the operation-control device, a given state-value of one or more of the subsets puts the state-value of at least another one of the remaining subsets under a predetermined plausibility condition associated to a respective correlation of the functional correlation model.

Further, a plausibility-checking unit that is connected to the input unit and to the functional-correlation storage unit is configured to determine a flag to the plausibility condition associated to the correlation of the state-values received and to provide a corresponding status signal.

A plausibility-check, in particular, is possible as soon as several state-values, that are interdependent as defined by a given functional correlation model, accumulate in the plausibility-checking unit. The flag is therefore a predetermined indication of whether or not the plausibility criterion applied to the state values of the subsets of the physical entities and/or operational states of the disperser is fulfilled or nor, i.e. of whether or not they are correlated in a specific way or not. Depending on the result of the plausibility criterion, the corresponding status signal indicative thereof is provided.

The operation-control device of the first aspect of the invention thus enables an improvement of the reliability of the control signals, i.e., the state values received from the external associated sensing-devices, which on their own lack the necessary reliability, by checking predetermined correlations of state values and/operational states in accordance with a given functional-correlation model.

The invention then enables an improvement of data-quality by automatic plausibility check of dependent state values of different subsets of physical entities and use of the data for a control strategy.

In the following, preferred developments of the operation-control device of the first aspect of the invention will be described with advantages associated therewith.

In a particular development, the operation-control device is a stand-alone device, separated from the disperser and/or the disperser system, which in then a device or system external to the operation-control device. In this embodiment, the operation-control device is communicatively connected to the sensing devices, which are also external to the operation-control device. In an alternative development, the operation control device is an operation control unit forming part of the disperser and/or of the system comprising the disperser. In yet another embodiment, the operation control unit integrated in the disperser and/or in the system is a decentralized control unit form by a plurality of sub-systems that cooperate to function as an operation-control device, wherein the sub-systems are communicatively connected, for instance via dedicated electrical connections, such as cables and/or a bus-system.

In a particular development, the operation-control device further comprises an operation-instruction storage unit configured to store one or more operation-instruction associated with a respective plausibility condition. The operation-control device also comprises an instruction-selection unit that is connected to the plausibility-checking unit and to the operation storage unit and configured to receive the status signal provided by the plausibility-checking unit. The instruction-selection unit is also configured to select, in accordance with the status signal, a determined specific operation-instruction from the plurality of operation-instruction associated to the applied plausibility criterion.

The operation-control device further comprises an output unit connected to the instruction-selection unit and configured to provide the selected operation-instruction for further control of the milling process.

The plausibility check can take place at different operational states of the disperser, such as in an idle state, or in a test cycle defined for this purpose, or in a fully-operating state. This allows both the associated sensing devices, the disperser and further associated equipment to be monitored.

In a development, the operation-instruction is used to select a preferred control strategy for the dispersing process, in particular in the form of a milling process, in dependence on the state values of at least two different physical entities and/or operational states,

As a non-limiting example, and for high-yield operation of the mill, the mill or the system comprising the mill is run at its highest capacity using the maximum amount of power allowable. In this case, the power amount is one of the physical entities. This, in turn, creates heat that is transferred to the product being milled, whose temperature one of the state values of the physical entities. In a first variant of control strategy for the dispersing process if the temperature at the product outlet exceeds a predetermined threshold amount, the control strategy involves increasing the flow of the cooling medium, wherein the flow of the cooling medium is another physical entity.

However, when the difference between the temperature of the cooling medium at the inlet and a at the outlet is below a predetermined threshold, the operation-control device is advantageously configured to change the control strategy. Thus, in a second variant of control strategy for the dispersing process it is favourable to indicate that the power amount supplied to the mill needs to be throttled shortly before a maximum product outlet temperature threshold is exceeded.

In another development, the functional correlation model is dynamically updated based on monitoring user operation as a function of the determined state-values provided by the associated sensing devices.

In a development the plausibility-checking unit is further configured to determine a first flag when the plausibility condition associated to the correlation of the state-values received is fulfilled and a second flag, different than the first flag when the plausibility condition associated to the correlation of the state-values received is not fulfilled.

In another development the output unit is configured to output a perceivable system-state signal in accordance with the selected operation instruction. In a development, the system-state signal is provided to a user interface comprising a screen or a lighting unit, or an acoustic unit. Additionally, or alternatively, the output unit of another development is configured to output the operation instruction, being indicative of a request for modifying a current state value of the physical entities or a current operational state of the disperser, to the disperser for further control of the dispersing process.

In a preferred development, the functional-correlation storage unit is configured to store functional correlation model comprising correlations of state-values of:

(a) a product flowrate and a cooling medium flowrate as the first subset and product inlet and outlet temperature, cooling medium inlet and outlet temperature as the second subset. and/or

(b) a product flowrate and, in particular additionally a cooling medium flowrate, as the first subset and pressure as the second subset; and/or

(c) electrical power provided as the first subset and temperature and product flowrate as the second subset; and/or

(d) a first temperature and a first product flowrate as the first subset and a second temperature and a second product flowrate as the second subset; and/or

(e) viscosity as the first subset and product flowrate as the second subset; and/or

(f) rotational speed, particularly of a pump or pumping system, as the first subset and product flowrate and pressure as the second subset; and/or

(g) rotational speed as the first subset and electrical power provided as the second subset; and/or

(h) product temperature and rotational speed as the first subset and temperature of the sealing medium as the second subset; and/or

(i) rotational speed as the first subset and product temperature as the second subset;

and/or

(j) product temperature as the first subset and product density as the second subset; and/or

(k) product temperature as the first subset and electrical power provided and cooling medium temperature as the second subset; and/or

(l) product flowrate as the first subset and electrical power provided as the second subset; and/or

(m) rotational speed, particularly rotational speed of a pump or a pumping system as the first subset and pressure as the second subset; and/or

(n) product flowrate and product viscosity as the first subset and pressure as the second subset; and/or

In the following, examples of generation and provision of operation instructions in accordance with some of the correlations of state-values of the respective functional correlation model outlined in sections (a)-(n) above will be described. This is however a non-limiting list and other examples of correlations and related plausibility criteria can be implemented.
At rest, and without product and cooling medium throughput, i.e., product and cooling medium flowrate equal to or close to zero, when the product temperature measured of product before and after the disperser, and/or the temperature of the cooling medium and/or the temperature of the sealing medium deviate significantly from the room temperature and from each other, the resulting operation instruction is indicative of a request to check temperature measuring points.
When rotating positive displacement pumps are used, neither throughput nor pressure increase with increasing pump speed. The resulting operation instruction is indicative of a request to check the pressure loss at a pump suction side.
In operation with flushing medium at low speed, the power amount used by the disperser deviates significantly from the usual values for flushing. The resulting operation instruction is indicative of a request to check the grinding media fill level.
The product temperature in the outlet does not increase with increasing disperser speed and otherwise the same operating conditions. The resulting operation instruction is indicative of a request to check the temperature sensor in the disperser's output.
In the operating state “Dispersing in circular operation”, the density of the product decreases at a constant product temperature. The resulting operation instruction is indicative of a request to reduce the speed of an agitator in a circular mixer to prevent the introduction of air through a large vortex.
During operation, the temperature of the sealing medium is as high at high disperser speed as at low disperser speed. The resulting operation instruction is indicative of a request to check the sealing medium line for clogging.

The term “device” in the operation-control device is meant to embrace a device as such or any arrangement for controlling operation of a disperser or a system comprising a disperser as described above, and which is preferably connected to an electronic control unit.

The operation control device is therefore, in some developments a stand-alone device having a processing unit, whereas in alternative embodiments it takes the form of a processing unit such as a control panel, preferably being a unit within a larger facility.

According to a second aspect of the present invention, a disperser having a rotor unit for rotating in a liquid is described. In particular, the disperser system comprises a disperser in the form of a mill or a dissolver. The disperser system comprises an operation-control device according to the first aspect of the invention. The disperser system further comprises a dispersing unit configured to carry out a dispersing process of a product, and at least two associated sensing devices configured to ascertain and provide the state values of the at least two different physical entities to the input unit of the operation-control device.

The sensing devices are thus communicatively connected to the input unit of the operation-control device and configured to provide the state values that are used by the plausibility-checking unit of the operation control device, in combination with the functional correlation model, to determine the flag to the plausibility condition associated to the correlation of the state values.

The disperser of the second aspect of the invention thus shares the advantages of the operation-control device of the first aspect or of any of its developments.

In a preferred development, the disperser system is a milling system comprising a mill that includes a milling unit configured to carry out a milling process of a product.

In particular, the sensing devices may include sensors configured to sense so-called extensive physical entities, such as the product flow or the volume of the current charge of product, intensive physical entities, such as pressure, temperature, etc., or physical entities associated to a quality of the product, such as, for instance viscosity or colour.

Particular correlations of a given functional correlation model having a quality-associated physical entity such as colour or viscosity as a subset, can advantageously be used as a feedback-based quality control of the process for determining parameter values more suitable for the dispersing process of subsequent product batches.

In a preferred development of the disperser of the second aspect, and in particular of a mill, each of the respective associated sensing device is one of

(i) a temperature sensing device configured to ascertain a temperature state value at one or more predetermined locations within the disperser or its surroundings; or

(ii) a flowrate sensing device configured to ascertain a flowrate state value of a material at one or more predetermined locations within the disperser; or

(iii) a pressure-sensing device configured to ascertain a pressure state value at a one or more predetermined locations within the disperser or its surroundings; or

(iv) a rotation-speed-sensing device configured to ascertain a rotation-speed state value of one or more predetermined rotating parts of the disperser, including a pumping unit and a milling unit, particularly in the case of mills; or

(v) an electrical power-sensing device configured to ascertain a power-consumption state value indicative of an amount of electrical power provided to one or more predetermined electrically-driven units of the disperser; or

(vi) a viscosity-sensing device configured to ascertain a viscosity state value of a material at one or more predetermined locations within the disperser; or

(vii) a density-sensing device configured to ascertain a density state value of a material at one or more predetermined locations within the disperser; or

(viii) a colour-sensing device configured to ascertain a colour value of a material at one or more predetermined locations within the disperser. The colour value may for instance be determined according to a particular colour space such as CIEXYZ or CIELUV or any alternative CIE colour space.

According to a third aspect of the present invention, a method for controlling operation of a disperser, in particular a mill such as a bead mill or a dissolver, and/or a system comprising a dispenser, with different physical entities, in particular material flowrate, pressure, viscosity, colour, rotation speed, electrical power, density and temperature, is provided. The method comprises receiving state-values of at least two of the different physical entities, an in particular, the method is characterized by receiving, from associated sensing devices, the state-values of the at least two different physical entities according to a functional correlation model, as it will be explained in the following.

The method is further characterized by providing the functional correlation model comprising one or more correlations of state-values of a number of subsets of different physical entities and/or operational states of the mill, wherein a state-value is indicative of a respective different state parameter of a milling process arising from a respective physical entity, and wherein a given state-value of one or more of the subsets puts the state-value of at least another one of the remaining subsets under a predetermined plausibility condition associated to a respective correlation of the functional correlation model. The method further includes, checking plausibility by determining a flag to the plausibility condition associated to the correlation of the state-values received and providing a corresponding status signal.

The method of the third aspect thus shares the advantages of the operation-control device of the first aspect or of any of its developments.

In a particular development, the method also comprises providing a number of operation-instructions associated with a respective plausibility condition, selecting, in accordance with the status signal, a determined specific operation-instruction from the plurality of operation-instruction associated to the applied plausibility criterion and providing the selected operation-instruction for further control of the milling process.

In a particular development, checking plausibility comprises determining a first flag when the plausibility condition associated to the correlation of the state-values received is fulfilled; and determining a second flag, different from the first flag, when the plausibility condition associated to the correlation of the state-values received is not fulfilled.

In another development, the method further comprises outputting a perceivable system state signal in accordance with the selected operation instruction.

According to a fourth aspect of the present invention, a computer program is described. The computer program comprises instructions which, when the program is executed by a processing unit of a computer and/or of the operation control-device, in particular a control panel of the operation-control device of the first aspect of the invention, cause the computer and/or the operation-control device to carry out any one of the method of the third aspect of the invention.

It shall be understood that the operation-control device of claim 1, the disperser of claim 6, the method of claim 8, and the computer program of claim 12, have similar and/or identical preferred embodiments, in particular, as defined in the dependent claims.

It shall be understood that a preferred embodiment of the present invention can also be any combination of the dependent claims or above embodiments with the respective independent claim.

These and other aspects of the invention will be apparent from and elucidated with reference to the embodiments described hereinafter.

In the following drawings:

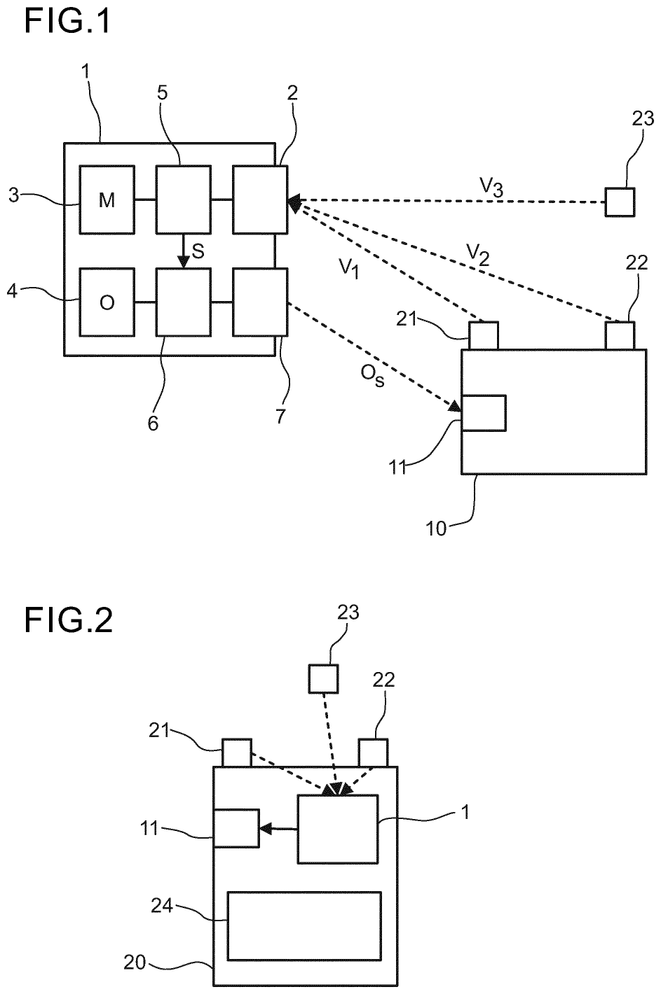

FIG. 1 shows a schematic block diagram of an operation-control device for controlling operation of a mill based on state-values of physical entities provided by associated sensing devices.

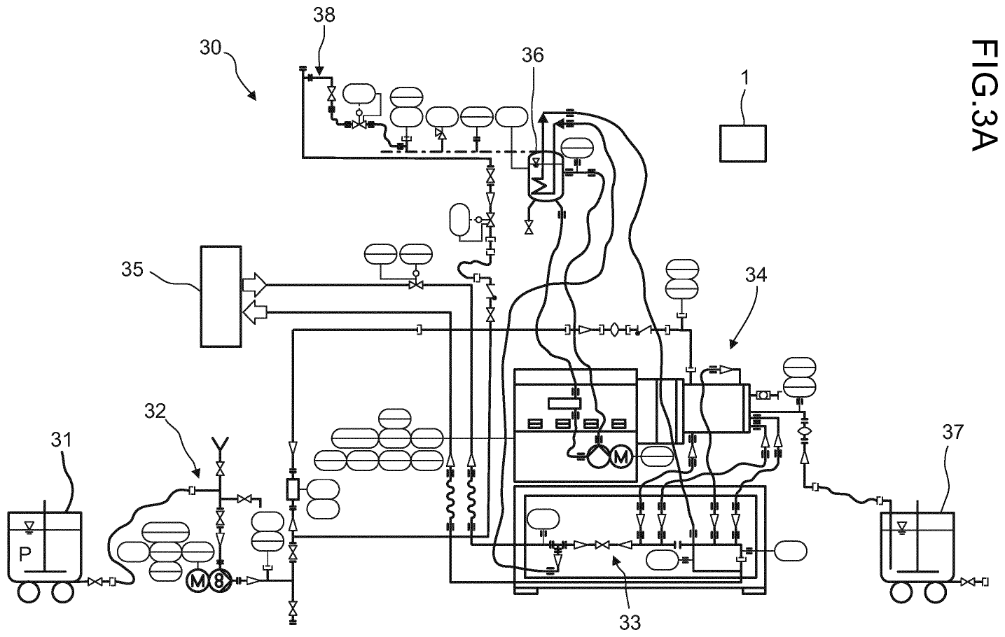

FIG. 2 shows a schematic block diagram of a mill comprising an operation control unit and associated sensing devices.

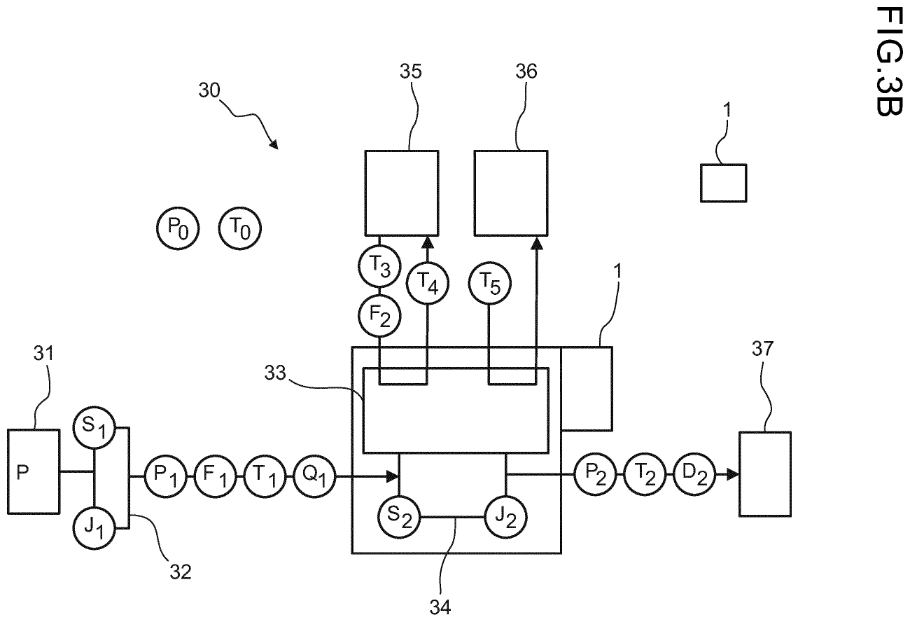

FIGS. 3A and 3B show diagrams of two particular embodiments of a disperser, in particular of a mill.

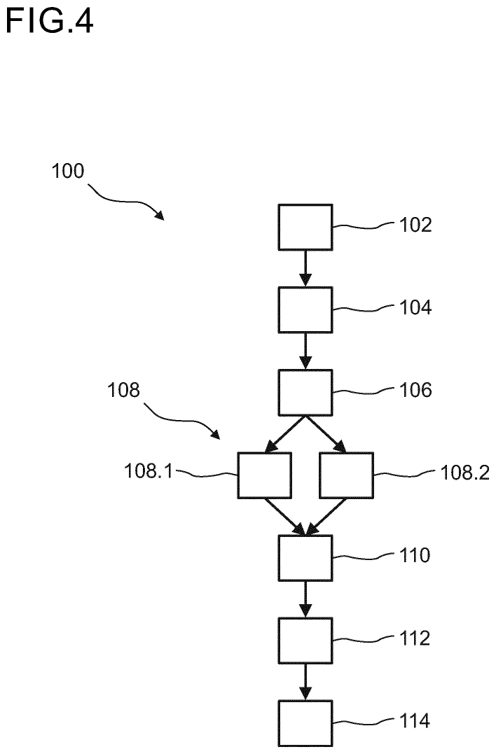

FIG. 4 shows a flow diagram of an embodiment of a method for control operation of a disperser.

The following discussion will be focused on a mill, in particular on a bead mill. However, the invention in not limited to mills and can be applied to other type of dispersers such as mixers, mills, dissolvers, kneaders, in particular agitator or stirrer or ball or pebble mills, further mixers and kneaders suitable for dispersing or dissolving pigments and other solids into a liquid or other dispersing devices as mentioned in the introduction.

FIG. 1 show a block diagram of an exemplary embodiment of an operation-control device 1 configured to control operation of a mill 10, wherein the mill 10 is shown here as a first exemplary non-restrictive embodiment of a disperser of general kind. The disperser in general, here the mill, has a process-control unit 11 and sensing devices 21, 22 and 23. The operation-control device comprises an input unit 2 that is configured to receive, from the associated sensing devices 21, 22 and 23, state values V₁, V₂, V₃ of at least two different physical entities associated to a milling process of the mill 1, respective in general a dispersing process of the disperser.

The current state values of the physical entities are thus related to a state of the dispersing process, in particular here a milling process. The physical entities whose state-values are sensed by the sensing device may include, for example, temperature, material flowrate, pressure, electrical power provided or consumed by a certain electronic unit of the mill, viscosity, density, rotation-speed of a particular rotating unit of the mill, such as the pump or the milling unit etc., and can be sensed at different positions or locations within the mill, such as inlets, outlets, milling unit, pumps, or even in the immediate vicinity of the mill, such as in the case of temperature and pressure. In this case, the temperature and pressure state-values sensed can be advantageously used as reference values for temperature and pressure state-values sensed within the mill.

The operation-control device 1 further comprises a functional-correlation storage unit 3 that configured to store at least one functional correlation model M comprising one or more correlations of state-values of a number of subsets of different physical entities and/or operational states of the mill. The state-value is indicative of a respective different state parameter of the milling process arising from a respective physical entity. A given functional-correlation model involves determining a correlation between the state-values of at least two different subsets of the physical entities such that a given state-value of one or more of the subsets puts the state-value of at least another one of the remaining subsets under a predetermined plausibility condition associated to a respective correlation of the functional correlation model.

The operation-control unit further comprises a plausibility-checking unit 5, connected to the input unit and to the functional-correlation storage unit and configured to determine a flag to the plausibility condition associated to the correlation of the state-values received and to provide a corresponding status signal S.

Advantageously, and optionally, the operation-control unit further comprises an operation-instruction storage unit 4 configured to store one or more operation-instructions associated to a respective plausibility condition. In this particular operation control unit, the state signal is received by an instruction-selection unit 6 that is configured to select, based on the state signal, a determined specific operation-instruction Os from the operation instructions O associated to the applied plausibility criterion.

Shown in FIG. 1 as a non-limiting example the mill 10, shown here as the first exemplary non-restrictive embodiment of a disperser of general kind, in the milling system for the mill 10 the sensing-device 21 is configured to ascertain an amount of electrical power delivered to the disperser, in particular here the mill 10, the sensing device 22 is configured to ascertain the current temperature value of an incoming product, and/or cooling medium, and/or sealing medium, and the sensing device 23 is configured to ascertain the current temperature value in the vicinity of the disperser, in particular here the mill 10.

A suitable functional-correlation model M includes correlation of state values of a first subset of physical entities including the amount of power provided, and of a second subset of physical entities including product temperature and/or cooling medium temperature and/or sealing medium temperature and reference temperature in the vicinity of the disperser, in particular here the mill 20. The correlation required by this particular functional correlation model is: when the mill is not operating (electrical power received is zero), does the ascertained temperature of the product and/or cooling medium and/or sealing medium differ from the ambient temperature in the vicinity by an amount larger than the predetermined difference-threshold amount. Based on this correlation and on the received state values, the plausibility-checking unit is configured to generate a flag indicative of whether the plausibility condition associated to the correlation is fulfilled. A set of operation-instructions that can be associated to this particular plausibility condition is for example: “keep the current operation state” and “signalize possible error: request check of temperature measurement locations”. In the case that the plausibility condition is fulfilled, i.e., that the temperature difference is smaller than the predetermined difference threshold amount, the plausibility-checking unit 5 provides a status signal indicative thereof and the instruction selection unit 6 receives the status signal and selects the instruction “keep the current operation state”. If, however, the flag is indicative of the plausibility condition not being fulfilled, i.e., that the temperature difference is larger than the predetermined difference threshold amount, the plausibility-checking unit 5 provides a status signal indicative thereof and the instruction selection unit 6 receives the status signal and selects the instruction “signalize possible error: request check of temperature measurement locations”. For instance, in the case of the mill 10 of FIG. 1, the selected operation-instruction Oₛ provided by an output unit 7 of the operation-control device is sent to the mill 10, in particular to a process-control unit 11 thereof, having a user interface for outputting a perceivable signal, such a coded-light or an acoustic alarm is case the operation-instruction is indicative of a possible malfunction of the mill or of a request to perform a check. Depending on the received operation instruction, the process control unit is configured to change an operational state of the mill. For instance, if the current correlation of the state values of the physical entities, according to a given plausibility condition of a functional correlation model indicates that the milling process should be immediately stopped, the process control unit is advantageously configured to change the state of the mill to stop the milling process.

Other possible, and non-limiting, examples of functional correlation models are described in sections (a)-(n) and the corresponding examples of generation and provision of operation instructions discussed above.

FIG. 2 shows, as a second exemplary non-restrictive embodiment of a disperser of general kind, a block diagram of an embodiment of a mill 20 comprising a milling unit 24 for performing a milling process on a product. The disperser, in particular here the mill 20, also comprises an operation-control device 1, as described with reference to FIG. 1, which is configured to receive, from the associated sensing devices 21, 22, 23, state-values of different physical entities and to provide an operation instruction in dependence on the received state-values. The dependency is based on a predetermined functional-correlation model and a corresponding plausibility condition associated to a respective correlation of the functional correlation model.

The operation instruction is provided to the control panel 11 which is configured to either steer the milling process or to output a perceivable system-state signal, for instance a green light in case the milling process is running optimally, or a red light having a predetermined respective lighting pattern, in case user interaction is needed to perform a predetermined corresponding check on the disperser, in particular here mill 20.

FIGS. 3A and 3B show in detail schematic diagrams specifically of a mill system with a mill 30, namely a disperser system comprising a mill as a specific kind of disperser. Still also here it is to be notified that the schematic diagrams specifically of a mill 30 can be considered as being a representative for analogue schematic diagrams of other dispersers considered to be constituted as a specific kind of fluid energy machines adapted to bring in energy into the pigments and other solids for dissolving the same into the liquid; in particular, to produce a paint or a lacquer. This is as mentioned in the introduction disperser like e.g. dissolvers and mills, in particular agitator or stirrer or ball or pebble mills, further mixers and kneaders suitable for dispersing or dissolving pigments and other solids into a liquid.

The mill 30 comprises a product inlet 31 for introducing a product to be milled into the mill. The product inlet is connected to a pump 32 for conveying the product to a milling unit 33. After the milling process is concluded, the milled product is conveyed to a product outlet 37. The mill also comprises a cooling unit 33 connected to a cooling medium reservoir 35 and to a sealing medium reservoir 36. Additionally, FIG. 3A shows a nitrogen rinsing circuit 38. The mill 30 comprises a plurality of sensing device configured to ascertain a state-value of a given physical entity and to provide said value to the operation-control device 1. In alternative embodiments, the operation-control device is integrated into the mill sharing a common housing. The sensing devices include, but are not restricted to,
temperature sensing devices T₁, T₂, T₃, T₄, T₅ configured to ascertain a temperature state value at one or more predetermined locations within the mill 30 or its surroundings, in particular in the vicinity of the mill T₀, of a product at the product inlet T₁, of the product at the product outlet T₂, of the cooling medium at the cooling medium inlet T₃ and outlet T₄ and of the sealing medium T₅,
flowrate sensing devices F₁, F₂ configured to ascertain a flowrate state value of a material at the product inlet and outlet respectively;
pressure-sensing devices P₀, P₁, P₂ configured to ascertain a pressure state value at a vicinity of the mill P₀, at the product inlet P₁ and at the product outlet P₂;
rotation-speed-sensing device S₁, S₂ configured to ascertain a rotation-speed state value of the pump S₁ and of the milling unit S₂;
electrical power-sensing devices J₁, J₂ configured to ascertain a power-consumption state value indicative of an amount of electrical power provided to one or more predetermined electrically-driven units of the mill, such as the pump J₁ and the milling unit J₂; or
a viscosity-sensing device Q₁ configured to ascertain a viscosity state value of a material at the product inlet; and
a density-sensing device D₂ configured to ascertain a density state value of a material at the product outlet.

FIG. 4 shows a flow diagram of a particular embodiment of a method 100 for controlling operation of a disperser system comprising a disperser of general kind, i.e. here an embodiment of a mill 10, 20, 30 the disperser, in particular here the mill, in particular a bead mill. The disperser is associated with different physical entities and/or operational states of the disperser, in particular material flowrate, pressure, viscosity, rotation speed, electrical power, density and temperature.

The method comprises, in a step 102, receiving state-values of at least two of the different physical entities and/or operational states of the disperser.

The method is characterized by, providing, in a step 104, a functional correlation model comprising one or more correlations of state-values of a number of subsets of different physical entities and/or the operational states of the mill, wherein a state-value is indicative of a respective different state parameter of a milling process arising from a respective physical entity, and wherein a given state-value of one or more of the subsets puts the state-value of at least another one of the remaining subsets under a predetermined plausibility condition associated to a respective correlation of the functional correlation model. The method further comprises, in a step 106, providing a number of operation-instructions associated with a respective plausibility condition.

Regarding step 102, and in view of the introduction of the functional correlation model, the step comprises receiving, from associated sensing devices, the state-values of at least two of the different physical entities according to the functional correlation model.

The method further comprises, in a step 108, checking plausibility by determining a flag to the plausibility condition associated to the correlation of the state-values received and providing a corresponding status signal, in a step 110, selecting, in accordance with status signal, a determined specific operation-instruction from the plurality of operation-instruction associated to the applied plausibility criterion, and in a step 112, providing the selected operation-instruction for further control of the milling process.

In a particular embodiment of the method, the step 108 comprises determining, in a step 108.1 a first flag when the plausibility condition associated to the correlation of the state-values received is fulfilled and determining, in a step 108.2 a second flag, different from the first flag, when the plausibility condition associated to the correlation of the state-values received is not fulfilled.

Further, in another embodiment, the method comprises, in a step 114, outputting a perceivable system state signal in accordance with the selected operation instruction.

In summary, the invention is directed to an operation-control device for controlling operation of a mill and comprising an input unit for receiving, from sensing devices, state-values of at least two different physical entities, such as temperature, pressure, etc.

A functional-correlation storage unit is configured to store a functional correlation model comprising correlations of state-values of subsets of physical entities and/or operational states of the mill and indicative of a predetermined plausibility condition associated to a respective correlation. A plausibility-checking unit is configured to determine a flag to the plausibility condition and to provide a corresponding status signal and an instruction-selection unit is configured and to select, in accordance with the status signal, a determined specific operation-instruction from a set of operation-instructions associated to the applied plausibility criterion for further control of the milling process.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single unit or device may fulfil the functions of several items recited in the claims. The mere fact that certain measures are recited in mutually different dependent claims does not indicate that a combination of these measures cannot be used to advantage.

A computer program may be stored/distributed on a suitable medium, such as an optical storage medium or a solid-state medium, supplied together with or as part of other hardware, but may also be distributed in other forms, such as via the Internet or other wired or wireless telecommunication systems.

Any reference signs in the claims should not be construed as limiting the scope.

### LIST OF REFERENCE SIGNS

1 Operation-control device
2 Input unit
3 Functional-correlation storage unit
4 Operation instruction storage unit
5 Plausibility-checking unit
6 Instruction-selection unit
7 Output unit
10, 20, 30 Mill
11 Process control unit
21, 22, 23 Associated sensing-devices
31 Product inlet
32 Pump
33 Cooling unit
24, 34 Milling unit
35 Cooling medium reservoir
36 Sealing medium reservoir
37 Product outlet
38 Nitrogen rinsing circuit
400 Method for controlling operation of a mill
400-4xx Method steps
D₂ Density sensor at product outlet
F₁ Product flowrate sensor at product inlet
F₂ Product flowrate sensor at product outlet
J₁ Electrical power sensor at pump
J₂ Electrical power sensor at mill
M Functional correlation model
O Operation instructions
Oₛ Selected operation instruction
P Product
P₀ Pressure sensor in the vicinity of the mill
P₁ Pressure sensor at product inlet
P₂ Pressure sensor at product outlet
Q₁ Viscosity sensor at product inlet
S Status signal
S₁ Rotation-speed sensor at pump
S₂ Rotation speed sensor at mill
T₀ Temperature sensor in the vicinity of the mill
T₁ Temperature sensor at product inlet
T₂ Temperature sensor at product outlet
T₃ Temperature sensor at cooling medium inlet
T₄ Temperature sensor at cooling medium outlet
T₅ Temperature sensor at sealing medium reservoir
V₁, V₂, V₃ State values of physical entities

1. An operation-control device adapted for controlling operation of a disperser, said disperser having a rotor unit for rotating in a liquid,
the operation-control device comprising:
an input unit for receiving, from external sensing devices, state-values of at least two different physical entities and/or operational states of the disperser associated to a dispersing process of the disperser;
a functional-correlation storage unit configured to store at least one functional correlation model comprising one or more correlations of state-values of subsets of different physical entities and/or operational states of the disperser, wherein a given state-value of at least one of the subsets puts the state-value of at least another subset under a predetermined plausibility condition associated to a correlation of the functional correlation model; and
a plausibility-checking unit connected to the input unit and to the functional-correlation storage unit and configured to determine a flag to the plausibility condition associated to the correlation of the state-values received and to provide a corresponding status signal.

2. The operation-control device of claim 1, further comprising:
an operation-instruction storage unit configured to store one or more operation-instructions associated with a respective plausibility condition; and/or
an instruction-selection unit connected to the plausibility-checking unit and to the operation-instruction storage unit and configured to receive the status signal and to select, in accordance with the status signal, a determined specific operation-instruction from the operation-instructions associated to the applied plausibility criterion; and/or
an output unit connected to the instruction-selection unit and configured to provide the selected operation-instruction for further control of the dispersing process.

3. The operation-control device of claim 1, wherein the disperser is a bead mill and the dispersing process is a milling process.

4. The operation-control device of claim 1, wherein the selected operation instruction is indicative of a request for modifying a current state value of the physical entities or a current operational state for further control of the dispersing process.

5. The operation-control device of claim 1, wherein the plausibility-checking unit is further configured to determine a first flag when the plausibility condition associated to the correlation of the state-values received is fulfilled and a second flag, different than the first flag when the plausibility condition associated to the correlation of the state-values received is not fulfilled.

6. The operation-control device of claim 1, wherein, when a second flag is determined when the plausibility condition associated to the correlation of the state-values received is not fulfilled, the selected operation instruction is indicative of a request for modifying a current state value of the physical entities or a current operational state for further control of the dispersing process; and/or when the second flag is determined, the selected operation instruction is indicative of a request to increase reliability of the state values received from the sensing devices.

7. The operation-control device of claim 6, wherein, when the second flag is determined, it is requested to check temperature measuring points or to check pressure loss at a pump suction side, or to check a grinding media fill level, or to check a temperature sensor in the disperser's output, or to reduce the speed of an agitator, or to check the sealing medium line.

8. The operation-control device of claim 1, wherein an output unit is configured to output a perceivable system-state signal in accordance with the selected operation instruction.

9. The operation-control device of claim 1, wherein the functional-correlation storage unit is configured to store the functional correlation model comprising correlations of state-values of:
a product flowrate and a cooling medium flowrate as the first subset and product temperature, cooling medium temperature and sealing medium temperature as the second subset; and/or
a product flowrate and a cooling medium flowrate as the first subset and pressure as the second subset; and/or
electrical power provided as the first subset and temperature and product flowrate as the second subset; and/or
a first temperature and a first product flowrate as the first subset and a second temperature and a second product flowrate as the second subset; and/or
viscosity as the first subset and product flowrate as the second subset; and/or
rotational speed as the first subset and product flowrate and pressure as the second subset; and/or
product flowrate as the first subset and pressure as the second subset; and/or
rotational speed as the first subset and electrical power provided as the second subset; and/or
product temperature and rotational speed as the first subset and temperature of the sealing medium as the second subset; and/or
rotational speed as the first subset and product temperature as the second subset; and/or
product temperature and cooling medium flowrate as the first set and temperature of the cooling medium as the second set; and/or
product temperature as the first subset and product density as the second subset; and/or
temperature as the first subset and electrical power provided and cooling medium temperature as the second subset; and/or
product flowrate as the first subset and electrical power provided as the second subset; and/or
rotational speed as the first subset and pressure as the second subset; and/or
product flowrate and product viscosity as the first subset and pressure as the second subset; and/or
temperature of the sealing medium as the first subset and rotational speed as the second subset.

10. A disperser system comprising:
an operation-control device according to claim 1; and
a disperser having a rotor unit for rotating in a liquid, the disperser system further comprising:
a dispersing unit configured to carry out a dispersing process of a product; and
at least two sensing devices configured to ascertain and provide the state values of the at least two different physical entities to the input unit of the operation-control device.

11. The disperser system of claim 10, wherein a respective sensing device is:
a temperature sensing device configured to ascertain a temperature state value at one or more predetermined locations within the disperser or its surroundings; or
a flowrate sensing device configured to ascertain a flowrate state value of a material at one or more predetermined locations within the disperser; or
a pressure-sensing device configured to ascertain a pressure state value at a one or more predetermined locations within the disperser or its surroundings; or
a rotation-speed-sensing device configured to ascertain a rotation-speed state value of one or more predetermined rotating parts of the disperser; or
an electrical power-sensing device configured to ascertain a power-consumption state value indicative of an amount of electrical power provided to one or more predetermined electrically-driven units of the disperser; or
a viscosity-sensing device configured to ascertain a viscosity state value of a material at one or more predetermined locations within the disperser; or
a density-sensing device configured to ascertain a density state value of a material at one or more predetermined locations within the disperser; or
a colour-sensing device configured to ascertain a colour value of a material at one or more predetermined locations within the disperser.

12. A method for controlling operation of a disperser, the method characterized by:
providing a functional correlation model comprising one or more correlations of state-values of subsets of different physical entities and/or operational states of the disperser, and wherein a given state-value of at least one of the subsets puts the state-value of at least another subset under a predetermined plausibility condition associated to a respective correlation of the functional correlation model;
receiving, from sensing devices, state-values of at least two different physical entities associated to a dispersing process of the disperser in accordance to the functional correlation model; and
checking plausibility by determining a flag to the plausibility condition associated to the correlation of the state-values received and providing a corresponding status signal.

13. The method of claim 12, further comprising:
providing a number of operation-instructions associated with a respective plausibility condition; and/or
selecting, in accordance with the status signal, a determined specific operation-instruction from the plurality of operation-instruction associated to the applied plausibility criterion; and/or
providing the selected operation-instruction for further control of the dispersing process.

14. The method of claim 12, wherein checking plausibility comprises:
determining a first flag when the plausibility condition associated to the correlation of the state-values received is fulfilled; and/or
determining a second flag, different from the first flag, when the plausibility condition associated to the correlation of the state-values received is not fulfilled.

15. A computer program comprising instructions which, when the program is executed by a processing unit of a computer and/or of the operation-control device, cause the computer and/or the operation-control device to carry out the method of claim 12.

16. The computer program of claim 15, wherein the program is executed by a control panel of an operation-control device comprising:
an input unit for receiving, from external sensing devices, state-values of at least two different physical entities and/or operational states of the disperser associated to a dispersing process of the disperser;
a functional-correlation storage unit configured to store at least one functional correlation model comprising one or more correlations of state-values of subsets of different physical entities and/or operational states of the disperser, wherein a given state-value of at least one of the subsets puts the state-value of at least another subset under a predetermined plausibility condition associated to a correlation of the functional correlation model; and
a plausibility-checking unit connected to the input unit and to the functional-correlation storage unit and configured to determine a flag to the plausibility condition associated to the correlation of the state-values received and to provide a corresponding status signal.

17. The operation-control device of claim 1, wherein said disperser is in the form of a mill, a bead mill, a high-speed disperser, or a dissolver.

18. The operation-control device of claim 6, wherein the selected operation instruction is indicative of a request to increase reliability of the state values received from the sensing devices.

19. The disperser system of claim 10, wherein said disperser is in the form of a mill or a dissolver.

20. The method of claim 12, wherein said disperser is a mill, a bead mill, a dissolver, and/or a disperser system comprising the disperser.
